(19) United States
(12) Patent Application Publication
(10) Pub. No.: US 2024/0155605 A1
(43) Pub. Date: May 9, 2024

(54) Frequency Domain Partial Transmission

(71) Applicant: Apple Inc., Cupertino, CA (US)

(72) Inventors: Weidong Yang, San Diego, CA (US); Dawei Zhang, Saratoga, CA (US); Wei Zeng, San Diego, CA (US); Chunxuan Ye, Cupertino, CA (US); Seyed Ali Akbar Fakoorian, San Diego, CA (US); Ankit Bhamri, Bad Nauheim (DE); Huaning Niu, Cupertino, CA (US); Oghenekome Oteri, San Diego, CA (US); Hong He, Cupertino, CA (US)

(21) Appl. No.: 18/495,334

(22) Filed: Oct. 26, 2023

Related U.S. Application Data
(60) Provisional application No. 63/422,728, filed on Nov. 4, 2022.

(51) Int. Cl. H04W 72/1268; H04W 72/02; H04W 72/0446; H04W 72/0453

(52) U.S. Cl. CPC H04W 72/1268; H04W 72/02; H04W 72/0446; H04W 72/0453

(57) ABSTRACT

This disclosure relates to techniques for performing partial frequency domain transmissions in a wireless communication system. A wireless device and a cellular base station may establish a wireless link. The wireless device may receive an uplink grant from the cellular base station. The uplink grant may provide a set of time domain resources and a set of frequency domain resources on which to perform an uplink transmission. The wireless device may select a subset of frequency domain resources from the set of frequency domain resources and perform the uplink transmission using the selected resources.

### PRIORITY INFORMATION

This application claims priority to U.S. provisional patent application Ser. No. 63/422,728, entitled “Frequency Domain Partial Transmission,” filed Nov. 4, 2022, which is hereby incorporated by reference in its entirety as though fully and completely set forth herein.

### FIELD

The present application relates to wireless communications, and more particularly to systems, apparatuses, and methods for performing partial frequency domain transmissions in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for performing partial frequency domain transmissions in a wireless communication system.

According to the techniques described herein, a wireless device may be capable of using a resource adjustment rule to select a subset of frequency domain resources provided by an uplink grant when not all of the frequency domain resources provided by the uplink grant are needed by the wireless device to perform an uplink transmission. The wireless device may perform the uplink transmission to a serving cellular base station using the selected subset of the frequency domain resources.

The cellular base station may perform transmission coordination between multiple such wireless devices, for example by providing uplink grants that include the same or at least partially overlapping resources to multiple wireless devices that are configured with different resource adjustment rules. For example, the resource adjustment rules with which the wireless devices are configured may be designed to minimize overlap between the frequency resources used by those wireless devices as much as possible.

The techniques may be used in conjunction with various possible resource allocation types. The resource adjustment rule(s) may be configured to be time-invariant or time-variant, according to various embodiments. It may be possible for a wireless device performing such frequency domain resource adjustment for an uplink transmission to signal which frequency domain resources are being used for the uplink transmission; it may also be possible that a wireless device performing such frequency domain resource adjustment for an uplink transmission does not explicitly indicate which frequency domain resources are being used for the uplink transmission, in which case it may be possible for the cellular base station to perform blind detection to determine the selection and extract control information for the uplink transmission. Note also that, in some instances, it may be possible to use techniques described herein in conjunction with either or both of configured grant or dynamic grant uplink grant types.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a flowchart diagram illustrating aspects of an exemplary possible method for performing partial frequency domain transmissions in a wireless communication system, according to some embodiments;

FIGS. 6-8 illustrate aspects of scenarios in which time domain and/or frequency domain resource adjustments for uplink transmissions could be performed, according to various embodiments;

FIG. 9 illustrates aspects of an example transmission coordination scheme that could be used in conjunction with frequency domain resource adjustments for uplink transmissions, according to some embodiments;

FIGS. 10-12 illustrate various aspects of possible wideband operation scenarios in which a bandwidth part can include multiple resource block sets, according to some embodiments;

FIG. 13 illustrates a possible example of configured grant uplink control information multiplexing over an uplink transmission channel according to one possible NR design, according to some embodiments; and

FIG. 14 illustrates example aspects of an approach to providing uplink control information in which the uplink control information is in a fixed location within the allocated frequency resources for an uplink transmission, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

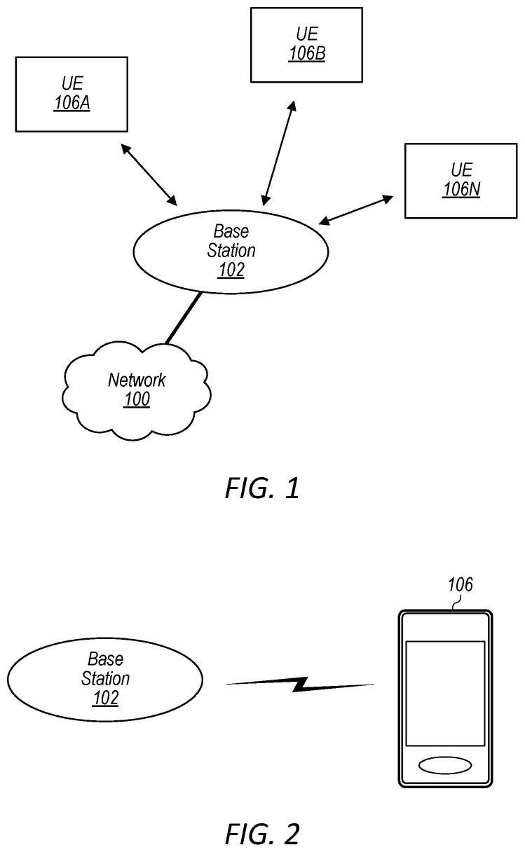

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

Note that, at least in some 3GPP NR contexts, base station (gNB) functionality can be split between a centralized unit (CU) and a distributed unit (DU). The illustrated base station 102 may support the functionality of either or both of a CU or a DU, in such a network deployment context, at least according to some embodiments. In some instances, the base station 102 may be configured to act as an integrated access and backhaul (IAB) donor (e.g., including IAB donor CU and/or IAB donor DU functionality). In some instances, the base station 102 may be configured to act as an IAB node (e.g., including IAB mobile termination (MT) and IAB-DU functionality). Other implementations are also possible.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform partial frequency domain transmissions in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM, etc.), and separate radios for communicating using each of Wi-Fi and BLUETOOTH™. Other configurations are also possible.

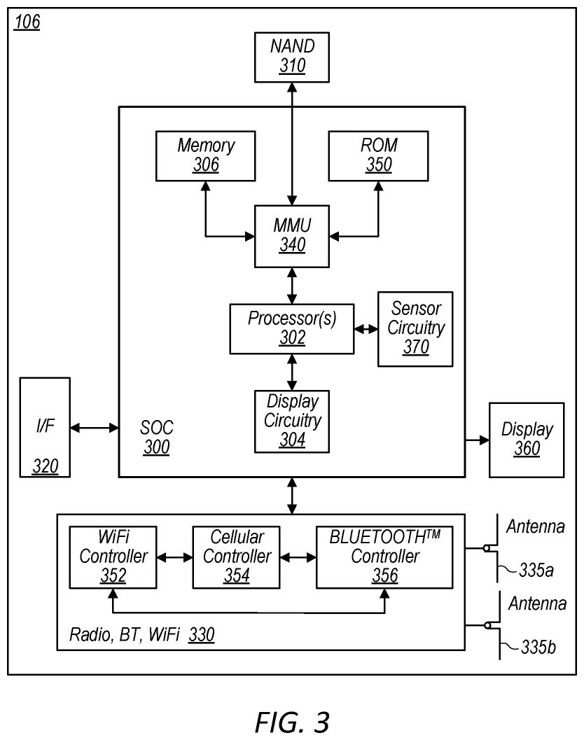

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector OF 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform partial frequency domain transmissions in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform partial frequency domain transmissions in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RAT s that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

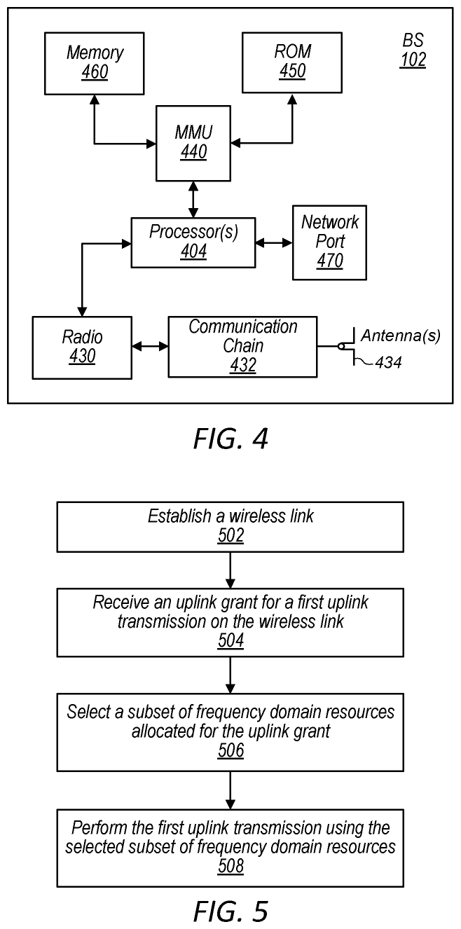

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNB s.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### FIG. 5—Partial Frequency Domain Transmissions

There may be cellular communication scenarios when a wireless device is over-provisioned with uplink transmission resources. Such scenarios could occur, for example, for low-latency traffic with variable frame sizes, for which it may be important to regularly provide uplink resources in sufficient quantity to handle larger frame sizes, but also for which only a portion of those uplink resources may be needed for smaller frame sizes. Such scenarios could also occur, for example, when a wireless device has a mixture of higher reliability traffic and lower reliability traffic, such that uplink resources may be provided in sufficient quantity to perform enough repetitions for the higher reliability traffic, although if none of the higher reliability traffic is present at the wireless device, the lower reliability traffic can be transmitted using fewer repetitions than could be supported with the amount of uplink resources provided to the wireless device.

Thus, at least in some scenarios, it may be beneficial to provide techniques for using a subset of the allocated resources for a transmission, e.g., to avoid unnecessary wireless device power consumption (e.g., by performing transmissions using more resources than needed) and/or inefficient network resource use. There may be a variety of possible ways of adjusting uplink transmission resource use, potentially including frequency domain resource adjustments and/or time domain resource adjustments. To illustrate one such set of possible techniques, FIG. 5 is a flowchart diagram illustrating a method for performing partial frequency domain transmissions in a wireless communication system, at least according to some embodiments.

Aspects of the method of FIG. 5 may be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

In 502, the wireless device may establish a wireless link with a cellular base station. According to some embodiments, the wireless link may include a cellular link according to 5G NR. For example, the wireless device may establish a session with an AMF entity of the cellular network by way of one or more gNB s that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least in some instances, establishing the wireless link(s) may include the wireless device providing capability information for the wireless device. Such capability information may include information relating to any of a variety of types of wireless device capabilities.

In 504, the wireless device may receive an uplink grant for an uplink transmission on the wireless link. According to some embodiments, the uplink grant may include a configured grant (CG) or a dynamic grant (DG). In some instances, the uplink grant may provide multiple uplink transmission occasions (e.g., a set of time domain uplink transmission resources). For each of the uplink transmission occasions, certain frequency resources (e.g., a set of frequency domain uplink transmission resources) may be provided by the uplink grant. The frequency resources may, for example, include a contiguous or non-contiguous allocation of physical resource blocks (PRBs).

In some instances, the set of frequency domain resources may be indicated using a resource block group (RBG) bitmap, for example in which each bit marked as “1” in the bitmap may indicate that a corresponding RBG is allocated to the wireless device by the uplink grant. In some instances, this type of signaling may be referred to as resource allocation type 0. As another possibility, the set of frequency domain resources may be indicated using resource indication value (RIV) signaling, for example in which an initial PRB and a PRB range for the set of frequency domain resources is indicated. In some instances, this type of signaling may be referred to as resource allocation type 1. In some instances, it may be possible that the set of frequency domain resources includes multiple sets of interlaced frequency resources. The interlaces allocated to the wireless device could be signaled using a bitmap-based approach or a RIV-based approach (e.g., possibly depending on subcarrier spacing (SCS) for the system and/or the number of possible interlaces configured/defined for the system). In some instances, such signaling to allocate interlaced frequency resources for uplink transmission may be referred to as resource allocation type 2.

In 506, the wireless device may select a subset of frequency domain resources allocated for the uplink grant. Selecting the subset of frequency domain resources may be based at least in part on determining that fewer frequency domain resources than allocated by the uplink grant are needed at the current time, for example based at least in part on uplink data buffer size for the uplink data buffer of the wireless device (e.g., if the amount of data in the data buffer can be transmitted using fewer frequency domain resources than are allocated by the uplink grant), and/or based at least in part on reliability target information for uplink data stored in the uplink data buffer of the wireless device (e.g., if fewer frequency domain resources are needed to meet the reliability target than are allocated by the uplink grant).

In addition to selecting an amount of frequency domain resources to use (and a corresponding amount of frequency domain resources to vacate), selecting the subset of frequency domain resources may also include selecting which of the frequency domain resources allocated by the uplink grant to use (e.g., which pattern of frequency domain resources among multiple possible patterns of frequency domain resources). In some instances, the selection of which frequency domain resources to use may be based at least in part on a resource adjustment rule, which could be configured by the cellular base station (e.g., the wireless device could receive an explicit indication of the resource adjustment rule for the wireless device from the cellular base station) and/or determined based on standard specification documents (e.g., the resource adjustment rule for the wireless device could be implicitly determined from multiple defined resource adjustment rules based on some wireless device characteristics or parameters or cellular network characteristics or parameters, among various possibilities).

A variety of resource adjustment rules may be possible, and could include time-invariant and/or time-variant resource adjustment rules. With a time-invariant resource adjustment rule, the wireless device may follow the same procedure for uplink resource selection for at least a certain amount of time, e.g., during the life of a call, or until the network sends an indication/signaling to modify the procedure. In some embodiments, the wireless device may use the same procedure as long as an internal condition is met, or as long as one or more conditions prescribed by specification are met, or as long as any or all of the conditions internal or external to wireless device implementation/standard body specifications' prescriptions for the current operation remain unchanged.

As one example, one time-invariant resource adjustment rule could include always selecting as many frequency resources as needed starting from the lowest indexed PRB or interlace allocated by the uplink grant. Another time-invariant resource adjustment rule could include selecting as many frequency resources as needed starting from the highest indexed PRB or interlace allocated by the uplink grant. A time-variant resource adjustment rule could include selecting as many frequency resources as needed starting from the lowest indexed PRB or interlace allocated by the uplink grant during even-indexed uplink slots and selecting as many frequency resources as needed starting from the highest indexed PRB or interlace allocated by the uplink grant during odd-indexed uplink slots. Another time-variant resource adjustment rule could include selecting as many frequency resources as needed starting from the highest indexed PRB or interlace allocated by the uplink grant during even-indexed uplink slots and selecting as many frequency resources as needed starting from the lowest indexed PRB or interlace allocated by the uplink grant during odd-indexed uplink slots. Numerous other resource adjustment rules (e.g., potentially including rules that result in non-contiguous patterns of frequency resources being selected, rules that are time-dependent based on other variables, etc.) are also possible. Note that, at least according to some embodiments, one possible benefit of using a time-variant resource adjustment rule could include potential randomization of interference effects on the selected subset of frequency domain resources for any given wireless device.

In some instances, the concept of RB sets may be used as another possible way of partitioning uplink frequency resources into portions that can be selected by a wireless device for partial frequency domain uplink transmission. For example, a wireless device could be configured (e.g., by a resource adjustment rule) to select resources according to the frequency domain resource allocation from the lowest index RB set, or the highest index RB set, etc.

In 508, the wireless device may perform the uplink transmission using the selected subset of frequency domain resources. In some instances, the wireless device may provide an indication (e.g., in uplink control information for the uplink transmission) of the selected subset of frequency domain resources to the cellular base station. In some embodiments, the uplink control information (e.g., configured grant uplink control information) may be provided in a subset of the allocated set of frequency domain resources for the uplink transmission. The portion of frequency domain resources that includes the uplink control information could, for example, include the smallest amount of frequency domain resources that could be selected (e.g., according to the resource adjustment rule and/or any other applicable parameters) by the wireless device to use to perform the uplink transmission. In other words, the portion of frequency domain resources that includes the uplink control information could be an even smaller subset of the subset of frequency resources selected by the wireless device for the uplink transmission, at least in some scenarios. Such an approach may allow the cellular base station to know the location of the uplink control information resources and perform detection accordingly regardless of what frequency domain resource adjustment the wireless device might make (or not make) for the uplink transmission. Thus, when the cellular base station receives the uplink transmission from the wireless device, the cellular base station may be able to receive the uplink control information for the uplink transmission and correspondingly determine that the uplink transmission is performed using the selected subset of frequency domain resources.

It may also be possible that uplink control information for the uplink transmission is carried on resources that are mapped across all of the selected frequency domain resources for the uplink transmission, e.g., with adjustment to uplink control information rate matching and mapping corresponding to the actually used frequency domain resources. In such a scenario, it may be possible for the cellular base station to extract the uplink control information (e.g., including configured grant uplink control information, potentially) and determine that the uplink transmission is performed using the selected subset of frequency domain resources by performing blind detection on the set of time domain resources and the set of frequency domain resources associated with the uplink grant.

At least according to some embodiments, such an approach to performing partial frequency domain uplink transmissions may be conducive to transmission coordination between multiple wireless devices, e.g., to potentially improve overall network resource use efficiency. For example, the cellular base station may establish a wireless link with another device, and may provide an uplink grant to that other wireless device, where the uplink grants for the wireless devices have at least some overlapping time and frequency resources. The different wireless devices may be configured with different (e.g., complementary) resource adjustment rules, such that if each of the wireless devices uses a subset of the allocated frequency resources according to their respective resource adjustment rules, it may be possible that there is no or minimal overlap between the resources actually used by the wireless devices. Thus, the cellular base station may be able to receive the uplink transmission from one wireless device on one subset of the allocated frequency domain resources, and to receive the uplink transmission from the other wireless device on a different subset of the allocated frequency domain resources, where the subsets of frequency domain resources for the different wireless devices are selected based on different resource adjustment rules.

Thus, at least according to some embodiments, the method of FIG. 5 may be used to provide a framework according to which a wireless device can perform uplink transmissions using a subset of the possible frequency domain resources, and thus to potentially reduce wireless device power consumption and/or to assist a cellular network to more effectively and efficiently use network resources in a variety of possible scenarios, at least in some instances.

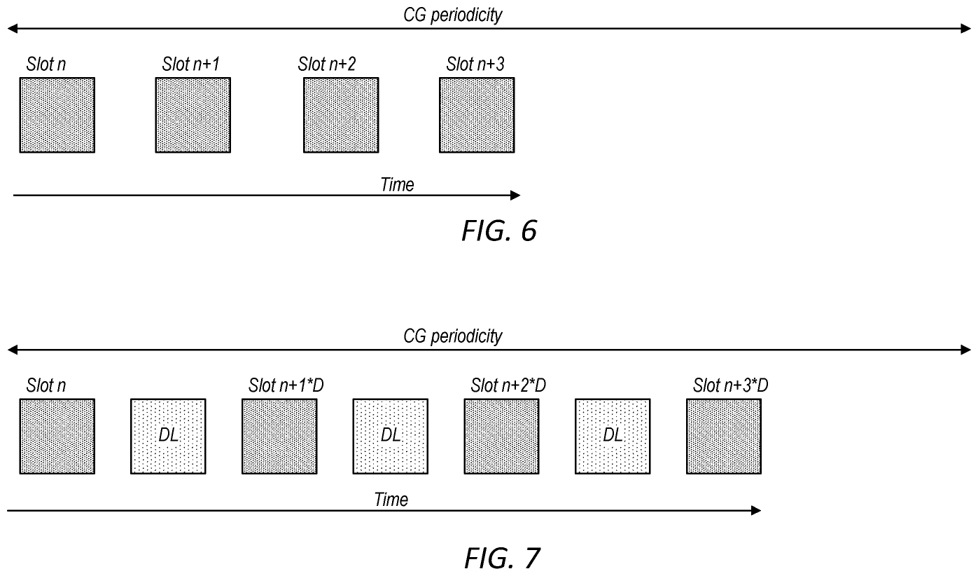

### FIGS. 6-14 and Additional Information

FIGS. 6-14 illustrate further aspects that might be used in conjunction with the method of FIG. 5 if desired. It should be noted, however, that the exemplary details illustrated in and described with respect to FIGS. 6-14 are not intended to be limiting to the disclosure as a whole: numerous variations and alternatives to the details provided herein below are possible and should be considered within the scope of the disclosure.

In at least some cellular communication techniques, uplink transmissions can be scheduled using dynamic grants or configured grants. In some scenarios it may be possible that a configured grant provides more resources than needed for the uplink traffic at a wireless device. For example, for extended reality (XR) traffic, the video frame size can vary with time, at least in some instances. If a configured grant (CG) is used to carry the XR traffic, e.g., for a video stream, time-frequency resources may be over-provisioned (e.g., to support the larger end of the range of possible video frame sizes, which may result in more resources being available than needed when the XR traffic is at the smaller end of the range of possible video frame sizes) in order to avoid prolonged transmissions, which may not be conducive to low-latency targets for transmission in the XR use case. As another example, for XR traffic, due to large quantization steps in the buffer status report (BSR) reporting, the gNB may not know precisely the buffer status of a UE. It could accordingly occur that a configured grant configuration for such a UE is configured for a traffic stream with a high reliability target when the current media access control (MAC) protocol data unit (PDU) doesn't contain any traffic from a high reliability traffic stream, in which case the UE may be able to use a lower reliability target for the configured grant, which may utilize fewer of the configured grant resources.

In view of the possibility of such over-provisioning of uplink resources, whether for configured grant or dynamic grant scenarios, and whether for XR use cases and/or other use cases, it may be useful to provide techniques for a UE to select which subset of the provisioned uplink resources to use to perform an uplink transmission, and/or to provide techniques for dynamically signaling the presence of unused uplink resources (e.g., CG physical uplink shared channel (PUSCH) occasion(s) or resource(s)) by a UE to a cellular network, e.g., to facilitate re-use of those unused resources for improved network resource use efficiency.

Multiple configured grant designs may be possible according to various cellular communication techniques and/or standards versions. According to some embodiments, some or all of single-slot PUSCH design, an ultra reliable low latency communication (URLLC) design, and/or a NR-U design may be used.

A single-slot PUSCH design could include a configured grant design in which the configured grant provides a single slot PUSCH transmission opportunity. This design may be supported from 3GPP Release 15, according to some embodiments. At least in some embodiments, given the same code rate and resource allocation (e.g., 20 physical resource blocks (PRBs) over 14 symbols), using a single PUSCH allocation (e.g., including 5 PRBs over 14 symbols) can be advantageous in harvesting coding gain compared with the case with two PUSCHs (e.g., with the first PUSCH including 5 PRBs over symbols 0-6 and the second PUSCH including 5 PRBs over symbols 7-13). Considering DL/UL split, design 0 may a more useable configuration than design 1 and design 2, according to some embodiments.

In a URLLC design (e.g., supported from 3GPP Release 16, according to some embodiments) multiple CG configurations with Type 1 (e.g., RRC configured) and Type 2 (e.g., DCI configured) may be supported on the same cell, and PUSCH repetition Type A and PUSCH repetition Type B may be supported for configured grants; note that for transmissions over slots/actual transmissions, the same transport block may be carried. In some embodiments, resource adjustment for such a design can be motivated to improve support for data with different reliability requirements. For example, for a scenario in which a first data stream and a second data stream are carried over the same CG configuration, but the first data stream has more stringent reliability requirements than the second data stream, the UE may be able to adjust the number of repetitions needed for a given uplink transmission depending on whether packets from the first data stream are sent or packets from the second data stream are sent.

In a NR-U design (e.g., supported from 3GPP Release 16, according to some embodiments), multiple occasions of PUSCH with different transport blocks may be supported. In some embodiments, resource adjustment for such a design can be motivated to improve support for scenarios in which packet size in a data stream varies over time (e.g., in which video frame size can vary from time to time), at least according to some embodiments.

It may be possible for resource use adjustments to be performed in the time domain and/or the frequency domain. FIGS. 6-8 illustrate aspects of scenarios in which such time domain and/or frequency domain resource adjustments could be performed, according to various embodiments.

FIG. 6 illustrates aspects of one possible scenario in which a CG PUSCH is associated with multiple transmission occasions (e.g., in a URLLC design or NR-U design scenario). In the illustrated example, a PUSCH is associated with transmissions in slot n, slot n+1, slot n+2, and slot n+3. Depending on the uplink traffic arrival at a UE and the resulting data buffer size and/or reliability target at the UE, the UE may be able to use a single occasion (e.g., slot n) or two occasions (e.g., slot n, slot n+1), while vacating the remaining resources (e.g., slots n+1 through n+3 may be vacated if only slot n is used, slots n+2 through n+3 may be vacated if slot n and slot n+1 are used, etc.). The vacated resources may not generate interference to other uplink transmissions, and the gNB may be able to schedule UEs in the vacated uplink transmission resources. However, it should be noted that the gNB may need a certain amount of time to process an indication received in slot n, e.g., such that an instantaneous reaction leading to a scheduling decision and corresponding signaling may not be possible in sufficient time to effectively use the vacated resources in response to an indication at slot n, at least in some instances, e.g., in particular if the configured grant includes consecutive slots. Note also that for a typical time division duplexing (TDD) split, it may be relatively unlikely that consecutive uplink slots are configured, at least according to some embodiments.

FIG. 7 illustrates aspects of another possible scenario in which a CG PUSCH is associated with multiple transmission occasions (e.g., in a URLLC design or NR-U design scenario). In the illustrated example, a PUSCH is associated with transmissions in slot n, slot n+1*D, slot n+2*D, and slot n+3*D. In other words, the “step” between neighboring occasions for the configured grant may be D (e.g., instead of 1), such that the occasions may be non-consecutive. Depending on the uplink traffic arrival at a UE and the resulting data buffer size and/or reliability target at the UE, the UE may be able to use a single occasion (e.g., slot n) or two occasions (e.g., slot n, slot n+1*D), while vacating the remaining resources (e.g., slots n+1*D through n+3*D may be vacated if only slot n is used, slots n+2*D through n+3*D may be vacated if slot n and slot n+1*D are used, etc.). The vacated resources may not generate interference to other uplink transmissions, and the gNB may be able to schedule UEs in the vacated uplink transmission resources. Such a setup may work with a typical TDD DL/UL split, and may provide more time for a gNB schedule to react to an indication received in slot n. However, since there may be DL slot(s) inserted between the uplink slots in the scenario of FIG. 7, in some instances it may be possible that one or more dynamic grants are used to schedule the uplink transmission(s) instead of a configured grant for such a scenario. Such a spread (in the time domain) of uplink slots may serve the low latency requirements for some XR uplink traffic well.

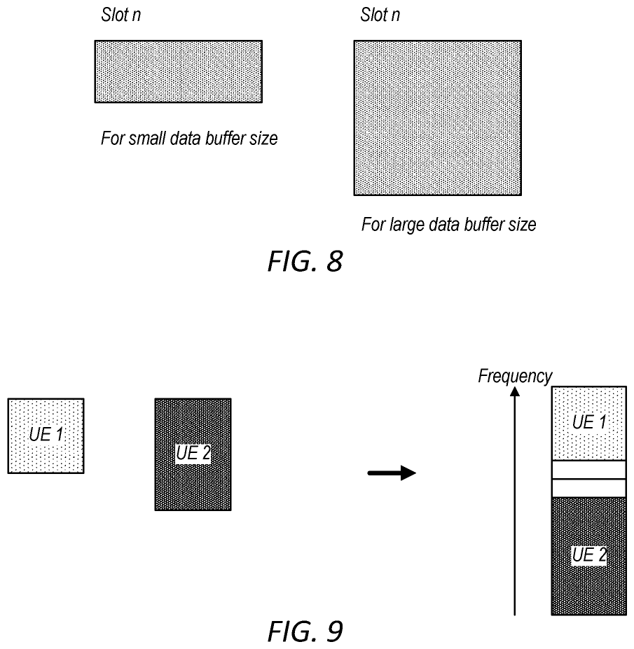

FIG. 8 illustrates aspects of a possible scenario in which a CG PUSCH is associated with a single occasion (e.g., in a single-slot PUSCH design), but the time-frequency resources taken by the CG PUSCH can be adapted according to the UE's data buffer size. As shown, in the illustrated scenario, for the single slot n of the CG PUSCH occasion, for small data buffer sizes, fewer resources may be used, while for large data buffer sizes, more resources may be used. Such a scheme may not suffer from any issue with DL/UL slot mismatch problems, and may work effectively for adjusting resources for at least some low latency XR uplink traffic use cases. However, in some scenarios, as this may involve a single occasion PUSCH transmission, it could be possible that a gNB would not be able to react fast enough to utilize the vacated resources for other UEs. Techniques for addressing this consideration are presented herein.

One possible set of techniques for making more effective use of uplink resources vacated by a UE that is adapting its resource usage for an uplink transmission may include transmission coordination techniques for coordinating transmissions with adaptive resource use between multiple UEs. In such a design, since the duration of the PUSCH can affect UCI multiplexing, it may be the case that adjustment of time-frequency resources taken for a specific CG PUSCH transmission is performed in the frequency domain, at least according to some embodiments. The adjustment of time-frequency resources in the frequency domain can be applied independently or in addition to the adjustment of time-frequency resources in the time domain. The transmission coordination may include configuring a first UE (UE 1) and a second UE (UE 2) with the same or overlapping resources for their respective configured grants. UE 1 and UE 2 may be in the same serving cell (UL MU-MIMO), or in different serving cells. If UE 1 and UE 2 are configured to adjust their respective resource utilization from the same direction in the frequency domain, that may result in frequent overlap (e.g., at least partially) between their transmissions in the frequency domain. However, if UE 1 and UE 2 are configured to adjust their respective resource utilization from different directions in the frequency domain, that may occasionally result in some overlap between their transmissions in the frequency domain, but may often result in no overlap occurring between their transmissions. For example, in the scenario illustrated in FIG. 9, UE 1 and UE 2 may be configured with the same resources for their respective configured grants for a given slot, UE 1 may be configured to adjust its resource use by taking as many PRBs as needed from the lowest indexed PRBs of the resources provided by the configured grant, and UE 2 may be configured to adjust its resource use by taking as many PRBs as needed from the highest indexed PRBs of the resources provided by the configured grant. As a result, in view of the actual resource utilization by each of UE 1 and UE 2 in the given slot of the illustrated example, there may be no overlap in the resource utilization by UE 1 and UE 2.

Thus, the resource adjustment rule at each UE in such a transmission coordination scheme may be configured differently to facilitate avoidance of overlap between PUSCH transmissions, at least according to some embodiments. In some instances, such coordination may be configured using time-invariant resource adjustment rules; for example, it could be the case that for a pair of UEs, one always takes PRBs as needed from the lowest indexed PRBs for all PUSCH transmissions, while the other always takes PRBs as needed from the highest indexed PRBs for all PUSCH transmissions. As another possibility, resource adjustment candidates from a resource adjustment rule may be time-variant at a UE; for example, it could be the case that for a pair of UEs, one takes PRBs as needed from the lowest indexed PRBs for PUSCH transmissions in certain uplink slots (e.g., even-indexed uplink slots counting from the start of a radio frame, as one possibility), and takes PRBs as needed from the highest indexed PRBs for PUSCH transmissions in certain other uplink slots (e.g., odd-indexed uplink slots counting from the start of a radio frame, as one possibility). The other UE in the pair could follow an inverse resource adjustment rule, for example such as to take PRBs as needed from the highest indexed PRBs for PUSCH transmissions in even-indexed uplink slots counting from the start of a radio frame and to take PRBs as needed from the lowest indexed PRBs for PUSCH transmissions in odd-indexed uplink slots counting from the start of a radio frame. At least in some instances, it may be the case that when the number of UEs in a cell or in a coordination area with multiple cells is larger, the interference experienced by a specific UE can be randomized through the use of such a time-variant set of resource adjustment rules.

In NR, there may be several resource allocation schemes for PUSCH transmissions. In some embodiments, PUSCH resource allocation type 0 may include use of a bitmap to indicate allocated resource block groups (RBGs). In some embodiments, “almost contiguous allocation,” e.g., as defined by 3GPP TS 38.101-1 v.17.7.0 for CP-OFDM for FR1, may be used for such an approach. In some embodiments, PUSCH resource allocation type 1 may include use of a resource indication value (RIV) to indicate the starting physical resource block (PRB) and the number of PRBs in the allocation. In some embodiments, PUSCH resource allocation type 2 may be used for interlaced transmissions, and may include interaction with resource block (RB) sets and intra-cell guard bands. It may also be possible that non-contiguous allocation beyond those provided by “almost contiguous transmission” under PUSCH resource allocation type 0 and interlaced PUSCH transmission under PUSCH resource allocation type 2 is used, where the uplink resources are divided into portions, and the gap between two neighboring utilized portions in a transmission may not be uniform.

For resource allocation type 0, according to one set of embodiments, the PUSCH allocation may be divided into Nₚₒᵣₜᵢₒₙₛ portions, where each portion comprises Nᵢ PRBs. Depending on the data buffer size, from 1 to k portions can be selected, where k≤Nₚₒᵣₜᵢₒₙₛ. For DFT-S-OFDM, if the resulting number of PRBs Σᵢ₌₁^{k}Nᵢ has a prime factor other than 2, 3, or 5, then the smallest number with all prime factor(s) from {2,3,5} which is larger than Σᵢ₌₁^{k}Nᵢ may be found; or the largest number with all prime factor(s) from {2,3,5} which is smaller than Σᵢ₌₁^{k}Nᵢ may be found.

In some embodiments, for resource allocation type 0, the PUSCH allocation may be divided into Nₚₒᵣₜᵢₒₙₛ portions, where each portion comprises Nᵢ PRBs. Depending on the data buffer size, from 1 to k portions can be selected, where k≤Nₚₒᵣₜᵢₒₙₛ For DFT-S-OFDM, if the resulting number of PRBs Σ_{i=(N}_{ₚₒᵣₜᵢₒₙₛ}₋ₖ₊₁₎^{N}^{ₚₒᵣₜᵢₒₙₛ}Nᵢ has a prime factor other than 2, 3, or 5, then the smallest number with all prime factor(s) from {2,3,5} which is larger than Σ_{i=(N}_{ₚₒᵣₜᵢₒₙₛ}₋ₖ₊₁₎^{N}^{ₚₒᵣₜᵢₒₙₛ}Nᵢ may be found; or the largest number with all prime factor(s) from {2,3,5} which is smaller than Σ_{i=(N}_{ₚₒᵣₜᵢₒₙₛ}₋ₖ₊₁₎^{N}^{ₚₒᵣₜᵢₒₙₛ}Nᵢ may be found.

Nₚₒᵣₜᵢₒₙₛ may be a number configured by gNB or defined in 3GPP specifications, according to various embodiments. For a scenario in which Nₚₒᵣₜᵢₒₙₛ is specified, Nₚₒᵣₜᵢₒₙₛ can be defined to be a function of the allocation size (e.g., below a threshold on the number of PRBs, Nₚₒᵣₜᵢₒₙₛ=1), if desired. In some embodiments, Nᵢ can be determined as Nᵢ=N_{PRBs}/Nₚₒᵣₜᵢₒₙₛ, except for the first portion or the last portion, for which floor, rounding, fix, ceiling, etc. can be applied to Nᵢ=floor(N_{PRBs}/Nₚₒᵣₜᵢₒₙₛ). Regarding size and ending PRB for the resource adjustment, the resulting number of PRBs can be required to be a multiple of RBG size (P) as defined in TS 38.214 v.17.3.0 (e.g., see therein Table 6.1.2.2.1-1: Nominal RBG size P), or the ending PRB may be required to be aligned with a RBG boundary, among various possibilities, as desired. Thus, for a bitmap allocation [00111111100], selection from the bitmap of the RBGs indicated by the bolded bits set to 1 could be performed, as an example.

Similar design options as described herein for resource allocation type 0 may also be possible for resource allocation type 1, according to some embodiments.

Interlaced transmission may be possible in NR-U and/or other contexts, according to various embodiments. Such transmission may be used in unlicensed bandwidth for channel occupancy bandwidth (e.g., for coexistence with other radio access technologies sharing the unlicensed spectrum, such as Wi-Fi) and/or power density (e.g., for coverage consideration), for example for enhanced license assisted access (eLAA) and NR-U communication techniques. For an interlaced uplink transmission, one PUSCH occasion can include one or more “interlaces” (e.g., interlaced groups of resource blocks). In some scenarios, similar to a comb structure that can be used in sounding reference signal (SRS) and demodulation reference signal (DMRS) designs, it may occur that two UEs (UE1 and UE2) can use orthogonal resources through random resource selection. Resource allocation through interlaces (e.g., as used in NR-U or using a variant design) can also be used in licensed spectrum, e.g., for XR uplink traffic and/or other use cases. In some instances, it may be possible that 5 interlaces at subcarrier spacing (SCS)=30 kHz and 10 interlaces at SCS=15 kHz are supported (e.g., in accordance with 3GPP TS 38.211 v.17.3.0 section 4.4.4.6).

Frequency domain resource allocation (FDRA) signaling design may be used for resource allocation type 2, interlaced PUSCH transmission, in some embodiments. For SCS at 30 kHz, a 5-bit bitmap could be used to indicate the selection of interlace(s). Thus, in a scenario in which the interlaces allocated are as [01110], as indicated by a DCI or configured for a configured grant, a UE can be configured to select which interlaces to use from the allocated interlaces. In one example, thus, the selection could be from the lowest available allocated interlaces for a UE, such that the selection candidates are [01110], [01110], or [01110]; that is, it may be the case that {interlace 1}, {interlace 1, interlace 2}, or {interlace 1, interlace 2, interlace 3} are the possible candidates for the UE. In another example, the selection could be from the highest available allocated interlaces for a UE, such that the selection candidates are [01110], [01110], or [01110]; that is, it may be the case that {interlace 3}, {interlace 2, interlace 3}, or {interlace 1, interlace 2, interlace 3} are the possible candidates for the UE.

For SCS at 15 kHz, it may be the case that an X=6 bits field may be used to indicate the start interlace index and number of contiguous interlace indices (RIV), and that the remaining up to 9 RIV values can be used to indicate specific pre-defined interlace combinations, according to some embodiments. In some instances, RIV values from 0 . . . 54 may indicate start interlace index and number of consecutive interlace indices, while RIV values from 55 . . . 63 may indicate specific interlace combinations (e.g., in accordance with 3GPP TS 36.213 v.17.3.0, as one possibility). At least according to some embodiments, adaptive resource selection according to a resource adjustment rule may also be possible using such a design, potentially both for cases with RIV≤54 and RIV≥55.

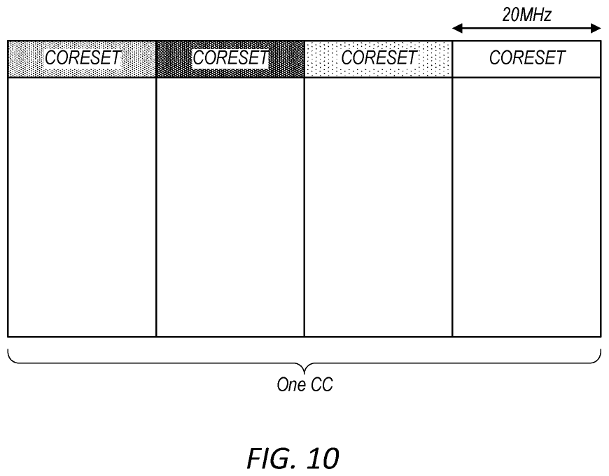

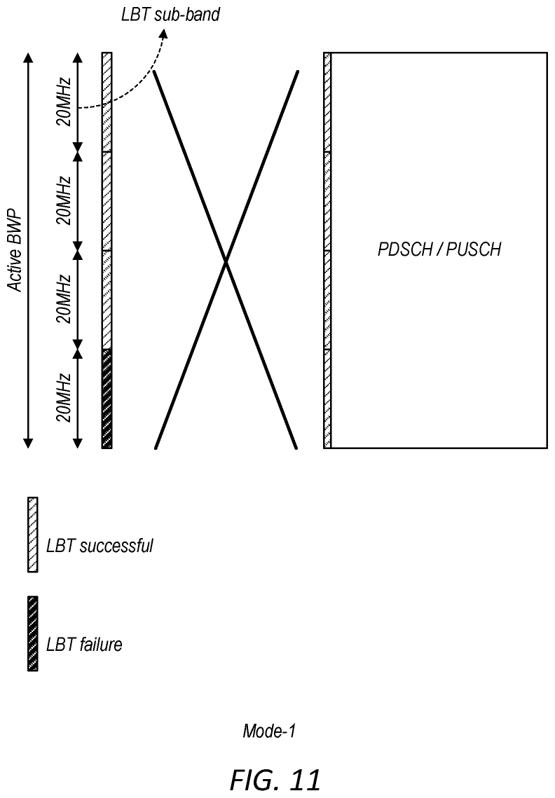

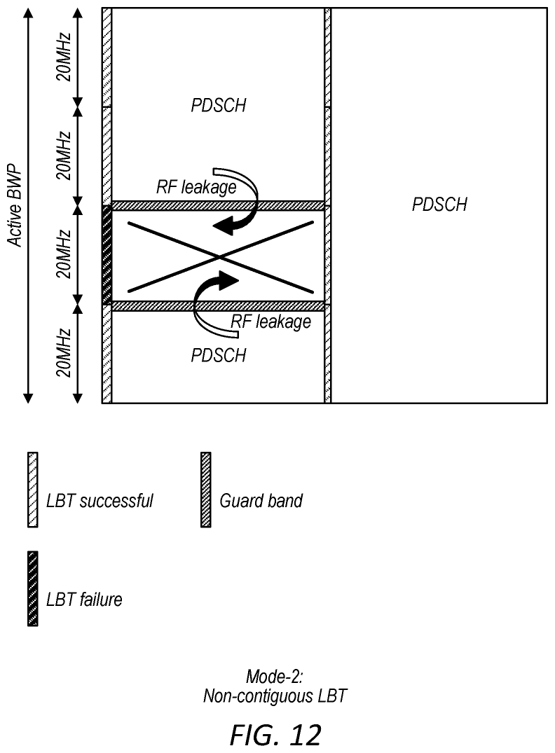

Adaptive resource selection according to a resource adjustment rule may also be possible for wideband operations, for example based on RB sets such as used in conjunction with NR-U operation in which a channel bandwidth can be larger than the listen-before-talk (LBT) bandwidth (e.g., 20 MHz or 10 MHz). FIG. 10 illustrates one component carrier (CC) that can be subdivided into such RB sets, according to some embodiments. FIG. 11 illustrates a contiguous LBT mode (“Mode-1”) in which LBT failure on any LBT sub-bands of the active bandwidth part (BWP) preclude transmission on the BWP. FIG. 12 illustrates a non-contiguous LBT mode (“Mode-2”) in which transmission LBT sub-bands with LBT success is possible even if LBT failure occurs on one or more LBT sub-bands of the BWP.

For wideband transmissions for the case of a serving cell with carrier bandwidth greater than LBT bandwidth, it may be the case that for DL reception, both Mode-1 and Mode-2 can be supported; for example, a gNB may perform PDSCH transmissions on part or the entirety of a single active BWP where clear channel assessment (CCA) is successful at the gNB. For UL transmission, it may be the case that Mode-1 is supported, such that a UE may transmit the PUSCH only if CCA is successful at the UE in all LBT bandwidths of the scheduled PUSCH.

If licensed spectrum is used for wideband operation (e.g., for XR traffic and/or other use cases), LBT may generally not be a factor in resource utilization. However, the concept of RB sets can be used as another possible technique for partitioning uplink resources into portions to facilitate transmission coordination; for example, a UE can be configured to select resources according to the FDRA from the lowest index RB set, or the highest index RB set, among various possibilities.

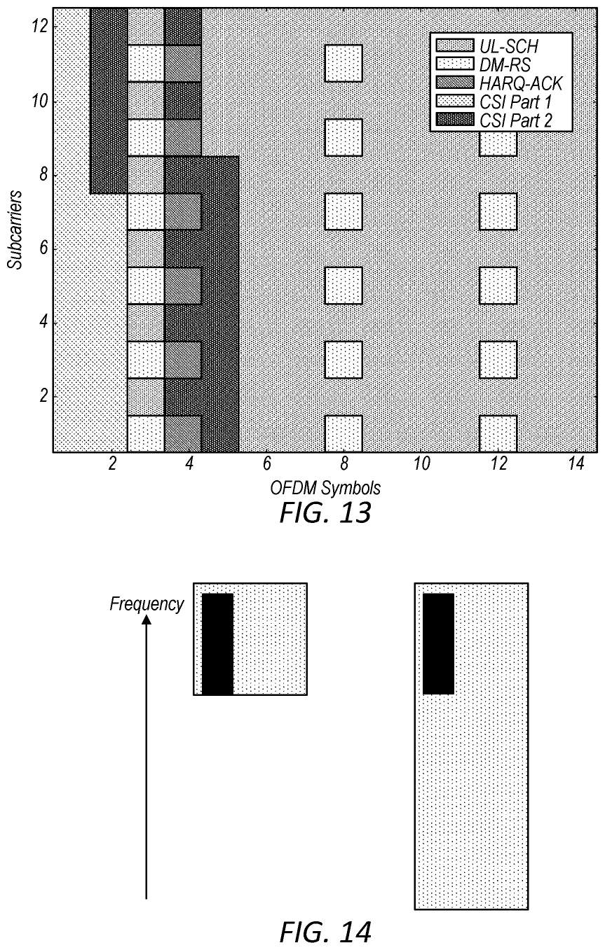

When a UE performs an uplink transmission with adaptive partial frequency domain resource use, there may be multiple options for handling provision of uplink control information. According to one possible design, the resources for hybrid automatic repeat request (HARQ) acknowledgement (ACK) signaling can also be used for CG uplink control information (UCI). FIG. 13 illustrates a possible example of UCI multiplexing over PUSCH according to one possible NR design, according to some embodiments. As shown, the mapping of the HARQ-ACK/CG-UCI resources is over the entire range of PRBs of the PUSCH allocation, e.g., to harvest frequency diversity.

In a scenario in which frequency domain resource adjustment occurs (e.g., such that fewer frequency domain resources are used than are allocated for a PUSCH transmission), as one possibility, it may be the case that UCI rate matching and mapping is performed according to the actually used frequency domain resources. In such a scenario, the gNB may be able to extract the UCI (including CG-UCI) by blind detection, according to some embodiments.

As another possibility, a minimally allowed amount of frequency resources may be configured or defined, and the UCI for the PUSCH transmission may be located only on those frequency resources. Hence, if there is a transmission at all from a UE, there may be a fixed location in which the gNB can perform UCI detection. FIG. 14 illustrates example aspects of such an approach, according to some embodiments. As shown, in the illustrated examples, whether a subset of the allocated frequency resources is used, or the full amount of allocated frequency resources is used, the UCI may be contained within the specified/configured minimally allowable subset of frequency resources.

In the following further exemplary embodiments are provided.

One set of embodiments may include a wireless device, comprising: an antenna; a radio operably coupled to the antenna; and a processor operably coupled to the radio; wherein the wireless device is configured to: establish a wireless link with a cellular base station; receive an uplink grant, wherein the uplink grant provides a set of time domain resources and a set of frequency domain resources on which to perform a first uplink transmission; select a subset of frequency domain resources from the set of frequency domain resources; and perform the first uplink transmission using the set of time domain resources and the selected subset of frequency domain resources.

According to some embodiments, the set of frequency domain resources is indicated using a resource block group (RBG) bitmap, wherein the subset of frequency domain resources selected includes one or more resource block groups (RBGs) marked as “1” in the RBG bitmap.

According to some embodiments, the set of frequency domain resources is indicated using resource indication value (RIV) signaling, wherein the subset of frequency domain resources selected includes one or more physical resource blocks (PRBs) indicated by the RIV signaling.

According to some embodiments, the set of frequency domain resources includes multiple sets of interlaced frequency resources, wherein the subset of frequency domain resources selected includes one or more of the sets of interlaced frequency resources.

According to some embodiments, selection of the subset of frequency domain resources from the set of frequency domain resources is performed based at least in part on a time-variant resource adjustment rule.

According to some embodiments, selection of the subset of frequency domain resources from the set of frequency domain resources is performed based at least in part on a time-invariant resource adjustment rule.

According to some embodiments, the wireless device is further configured to: provide an indication of the selected subset of frequency domain resources to the cellular base station.

Another set of embodiments may include a method, comprising: by a wireless device: establishing a wireless link with a cellular base station; receiving an uplink grant, wherein the uplink grant provides a set of frequency domain resources on which to perform an uplink transmission; selecting a subset of frequency domain resources from the set of frequency domain resources; and performing the uplink transmission using the selected subset of frequency domain resources.

According to some embodiments, selecting the subset of frequency domain resources from the set of frequency domain resources is based at least in part on one or more of: uplink data buffer size for an uplink data buffer of the wireless device; or reliability target information for uplink data stored in the uplink data buffer of the wireless device.

According to some embodiments, selection of the subset of frequency domain resources from the set of frequency domain resources is performed based on a time-variant or time-invariant resource adjustment rule.

According to some embodiments, the method further comprises: receiving an indication of the resource adjustment rule from the cellular base station.

According to some embodiments, the uplink grant includes a dynamic grant.

According to some embodiments, the uplink grant includes a configured grant.

Yet another set of embodiments includes an apparatus, comprising: a processor configured to cause a cellular base station to: establish a wireless link with a first wireless device; provide a first uplink grant to the first wireless device, wherein the first uplink grant provides a first set of time domain resources and a first set of frequency domain resources on which to perform a first uplink transmission; and receive the first uplink transmission using the first set of time domain resources and a subset of the first set of frequency domain resources.

According to some embodiments, wherein the first set of frequency domain resources is indicated using one of: a resource block group (RBG) bitmap; or resource indication value (RIV) signaling.

According to some embodiments, the first set of frequency domain resources includes multiple sets of interlaced frequency resources, wherein the subset of the first set of frequency domain resources includes one or more of the sets of interlaced frequency resources.

According to some embodiments, the processor is further configured to cause the cellular base station to: provide an indication of a resource adjustment rule to the first wireless device, wherein the subset of the first set of frequency domain resources is selected by the first wireless device based on the resource adjustment rule.

According to some embodiments, the processor is further configured to cause the cellular base station to: perform blind detection on the first set of time domain resources and the first set of frequency domain resources to determine that the first uplink transmission is performed using the subset of the first set of frequency domain resources.

According to some embodiments, the processor is further configured to cause the cellular base station to: receive uplink control information for the first uplink transmission, wherein the uplink control information for the first uplink transmission indicates that the first uplink transmission is performed using the subset of the first set of frequency domain resources.

According to some embodiments, the processor is further configured to cause the cellular base station to: establish a wireless link with a second wireless device; provide a second uplink grant to the second wireless device, wherein the second uplink grant provides a second set of time domain resources and a second set of frequency domain resources on which to perform a second uplink transmission, wherein the first set of time domain resources and the first set of frequency domain resources overlap at least partially with the second set of time domain resources and the second set of frequency domain resources; and receive the second uplink transmission using the second set of time domain resources and a subset of the second set of frequency domain resources, wherein the subset of the first set of frequency domain resources and the subset of the second set of frequency domain resources are selected based on different resource adjustment rules.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A wireless device, comprising:
radio circuitry; and
a processor operably coupled to the radio circuitry;
wherein the wireless device is configured to:
receive an uplink grant that provides a set of time domain resources and a set of frequency domain resources on which to perform a first uplink transmission;
select a subset of frequency domain resources from the set of frequency domain resources; and
perform the first uplink transmission using the set of time domain resources and the selected subset of frequency domain resources.

2. The wireless device of claim 1,
wherein the set of frequency domain resources is indicated using a resource block group (RBG) bitmap, wherein the subset of frequency domain resources selected includes one or more resource block groups (RBGs) marked as “1” in the RBG bitmap.

3. The wireless device of claim 1,
wherein the set of frequency domain resources is indicated using resource indication value (RIV) signaling, wherein the subset of frequency domain resources selected includes one or more physical resource blocks (PRBs) indicated by the RIV signaling.

4. The wireless device of claim 1,
wherein the set of frequency domain resources includes multiple sets of interlaced frequency resources, wherein the subset of frequency domain resources selected includes one or more of the sets of interlaced frequency resources.

5. The wireless device of claim 1, wherein the wireless device is further configured to:
select the subset of frequency domain resources from the set of frequency domain resources based at least in part on a time-variant resource adjustment rule.

6. The wireless device of claim 1, wherein the wireless device is further configured to:
select the subset of frequency domain resources from the set of frequency domain resources based at least in part on a time-invariant resource adjustment rule.

7. The wireless device of claim 1, wherein the wireless device is further configured to:
provide an indication of the selected subset of frequency domain resources to a cellular base station.

8. A method, comprising:
receiving an uplink grant that provides a set of frequency domain resources on which to perform an uplink transmission;
selecting a subset of frequency domain resources from the set of frequency domain resources; and
performing the uplink transmission using the selected subset of frequency domain resources.

9. The method of claim 8, further comprising:
selecting the subset of frequency domain resources from the set of frequency domain resources based at least in part on one or more of:
uplink data buffer size for an uplink data buffer of the wireless device; or
reliability target information for uplink data stored in the uplink data buffer of the wireless device.

10. The method of claim 8, further comprising:
selecting the subset of frequency domain resources from the set of frequency domain resources based on a time-variant or time-invariant resource adjustment rule.

11. The method of claim 10, further comprising:
receiving an indication of the resource adjustment rule from a cellular base station.

12. The method of claim 8,
wherein the uplink grant includes a dynamic grant.

13. The method of claim 8,
wherein the uplink grant includes a configured grant.

14. A non-transitory memory element storing instructions executable by a processor to:
provide, to a first wireless device, a first uplink grant that provides a first set of time domain resources and a first set of frequency domain resources on which to perform a first uplink transmission; and
receive the first uplink transmission using the first set of time domain resources and a subset of the first set of frequency domain resources.

15. The non-transitory memory element of claim 14,
wherein the first set of frequency domain resources is indicated using one of:
a resource block group (RBG) bitmap; or
resource indication value (RIV) signaling.

16. The non-transitory memory element of claim 14,
wherein the first set of frequency domain resources includes multiple sets of interlaced frequency resources, wherein the subset of the first set of frequency domain resources includes one or more of the sets of interlaced frequency resources.

17. The non-transitory memory element of claim 14, wherein the instructions are further executable by the processor to:
provide an indication of a resource adjustment rule to the first wireless device, wherein the subset of the first set of frequency domain resources is selected by the first wireless device based on the resource adjustment rule.

18. The non-transitory memory element of claim 14, wherein the instructions are further executable by the processor to:
perform blind detection on the first set of time domain resources and the first set of frequency domain resources to determine that the first uplink transmission is performed using the subset of the first set of frequency domain resources.

19. The non-transitory memory element of claim 14, wherein the instructions are further executable by the processor to:
receive uplink control information for the first uplink transmission, wherein the uplink control information for the first uplink transmission indicates that the first uplink transmission is performed using the subset of the first set of frequency domain resources.

20. The non-transitory memory element of claim 14, wherein the instructions are further executable by the processor to:
provide a second uplink grant to a second wireless device, wherein the second uplink grant provides a second set of time domain resources and a second set of frequency domain resources on which to perform a second uplink transmission, wherein the first set of time domain resources and the first set of frequency domain resources overlap at least partially with the second set of time domain resources and the second set of frequency domain resources; and
receive the second uplink transmission using the second set of time domain resources and a subset of the second set of frequency domain resources,
wherein the subset of the first set of frequency domain resources and the subset of the second set of frequency domain resources are selected based on different resource adjustment rules.
